(19) United States
(12) Patent Application Publication
(10) Pub. No.: US 2015/0345916 A1
(43) Pub. Date: Dec. 3, 2015

(54) Energetic Device Labeling

(71) Applicant: Hunting Titan, Inc., Pampa, TX (US)

(72) Inventors: Christopher Brian Sokolove, Maypearl, TX (US); Aaron Lee McGregor, Hillsboro, TX (US)

(73) Assignee: Hunting Titan, Inc., Pampa, TX (US)

(21) Appl. No.: 14/520,647

(22) Filed: Oct. 22, 2014

Related U.S. Application Data
(60) Provisional application No. 62/005,068, filed on May 30, 2014.

(51) Int. Cl. F42B 1/02; B23K 26/40; B23K 26/36

(52) U.S. Cl. CPC F42B 1/02; B23K 26/365; B23K 26/4095

(57) ABSTRACT

A method and apparatus for including information on a shaped charge.

### FIELD

The invention generally relates to perforating guns used in a subterranean environment. More particularly, the invention relates to labeling energetic device used in the oilfield with relevant manufacturing and safety information.

### BACKGROUND

Generally, when completing a subterranean well for the production of fluids, minerals, or gases from underground reservoirs, several types of tubulars are placed downhole as part of the drilling, exploration, and completions process. These tubulars can include casing, tubing, pipes, liners, and devices conveyed downhole by tubulars of various types. Each well is unique, so combinations of different tubulars may be lowered into a well for a multitude of purposes.

A subsurface or subterranean well transits one or more formations. The formation is a body of rock or strata that contains one or more compositions. The formation is treated as a continuous body. Within the formation hydrocarbon deposits may exist. Typically a wellbore will be drilled from a surface location, placing a hole into a formation of interest. Completion equipment will be put into place, including casing, tubing, and other downhole equipment as needed. Perforating the casing and the formation with a perforating gun is a well known method in the art for accessing hydrocarbon deposits within a formation from a wellbore.

Explosively perforating the formation using a shaped charge is a widely known method for completing an oil well. A shaped charge is a term of art for a device that when detonated generates a focused explosive output. This is achieved in part by the geometry of the explosive in conjunction with a liner in the explosive material. Generally, a shaped charge includes a metal case that contains an explosive material with a concave shape, which has a thin metal liner on the inner surface. Many materials are used for the liner; some of the more common metals include brass, copper, tungsten, and lead. When the explosive detonates the liner metal is compressed into a super-heated, super pressurized jet that can penetrate metal, concrete, and rock.

A perforating gun has a gun body. The gun body typically is composed of metal and is cylindrical in shape. Within a typical gun tube is a charge holder, which is a tube that is designed to hold the actual shaped charges. The charge holder will contain cutouts called charge holes where the shaped charges will be placed.

When placing any type of tubular downhole there is a risk that it can get stuck in the well. This can happen for several reasons including: the well has partially collapsed, operator error, or due to the geometry of the drilling path. Once the tubular becomes stuck, a variety of non-destructive means are available for the operator of the rig to try and free the tubular. These include rotating the tubular, jolting the tubular, or simply pulling up on the tubular until it comes free. However, if these options are unsuccessful then the operator might have to resort to using a cutting or severing tool such as a jet cutter to cut the tubular.

Tubulars may also be cut in abandonment operations. Abandonment operations are increasingly subject to regulations to provide for minimizing the long term environmental impact of abandoned wells. An operator will often times have to remove miles of tubulars while contending with cemented equipment, damage in the wellbore, or other unforeseen difficulties. The jet cutter is a critical tool that allows the operator to cut and retrieve tubulars from the well. The demand for cleaner abandoned wells, in conjunction with the growing number of idle wells in general, is a driving force in the market for jet cutters.

A jet cutter is an explosive shaped charge that has a circumferential V-type shape. The explosive is combined with a liner. The components are all contained in a housing. The jet cutter is lowered to the desired point where the separation of the tubular is desired. When the jet cutter is detonated, it will generate a jet of high energy plasma, typically around 360 degrees, that will severe the tubular. Afterwards, the upper portion of the tubular is pulled out of the well. Then the operator can use a fishing tool to remove the still stuck lower portion of the tubular.

While other types of tubular cutters are available, including mechanical cutting devices and chemical cutters, the focus of this invention is on explosive shaped charge jet cutters that are widely used throughout the oil industry. Jet cutters have increased in popularity due to improvements in reliability and the increased use of horizontal wells.

A shaped charge is a term of art for a device that when detonated generates a focused explosive output. This is achieved in part by the geometry of the explosive in conjunction with a liner in the explosive material. Many materials are used for the liner; some of the more common metals include brass, copper, tungsten, and lead. When the explosive detonates the liner metal is compressed into a super-heated, super pressurized jet that can penetrate metal, concrete, and rock.

Shaped charges must be transported from a manufacturing facility to the field. The high explosives must be maintained and designed such that the risk of any premature or unintended detonation is mitigated against. Shaped charges are transported by a variety of transportation methods, in all climates and temperature ranges, and may be subject to temperature variations, vibrations, mishandling, and tire. They often have to travel across multiple legal boundaries, with varying safety requirements.

Because of the nature of high explosives, there are local, federal, and international requirements that the shaped charges be labeled to convey key identification information. Regulatory agencies have desired to have shaped charges identifiable and traceable. Applying identification information to shaped charges has posed many problems to manufacturers. There are requirements that the information placed on a shaped charge is both readable to people and digital. Applying digitally readable symbols to the curved surface of a shaped charge has been particularly difficult.

One problem with shaped charges is that they are curved. Applying the information to a curved surface is more difficult and reading the same information by a digital scanner poses problems. Another problem is that the shaped charge case is metal and therefore the surface is often highly reflective, producing glare. This makes reading the information with either a human eye or an electronic scanner difficult as there is insufficient contrast.

Laser marking is a common and preferred method for applying identification information to shaped charges because it is fast and permanent. Traditionally, a laser oxidizes the surface of the outer wall of the shaped charge to create dark areas which contrast against a light background. The surface coating or plating that is on the surface of the shaped charge may be removed to expose a lighter metal surface to increase the contrast. However, this increases the reflectivity of the metal by exposing areas of reflective metal on a surface that is generally already reflective. The end result is that digital readers and humans have a difficult time reading the information on a shaped charge.

A more effective means of applying information to shaped charge is needed so that people and digital readers can ascertain important information of the shaped charge with little to no error or failed readings.

### SUMMARY OF INVENTION

In at least one example of the invention, an explosive charge case comprising a metallic housing, a portion of the metallic housing having a relatively dark surface finish, a portion of the metallic housing having exposed bare metal, wherein the arrangement of the exposed bare metal and relatively dark surface finish convey information.

Another example of the invention is an explosive shaped charge comprising a metallic charge case, a portion of the metallic housing having a relatively dark surface finish, a portion of the metallic housing having exposed bare metal, wherein the arrangement of the exposed bare metal and relatively dark surface finish convey information.

Another example of the invention includes a method for labeling a shaped charge comprising finishing an outer surface of a shaped charge case with a relatively dark surface finish, removing a portion of the surface finish to expose bare metal, wherein the arrangement of the exposed bare metal and relatively dark surface finish conveys information.

In a variation of any of the examples listed of the invention, the arrangement of the exposed bare metal and relatively dark surface finish comprise a barcode, a two-dimensional barcode, an identification number, a manufacturer name, a manufacturer location, a place of manufacture, convey an explosive charge weight, an explosive charge type, an explosive warning, corrosion resistant finish, is a black zinc chromate finish, is a zinc chromate finish without brighteners, is an olive zinc chromate finish, is a zinc chromate finish.

Moreover, in any of the examples, the identification number may include at least a serial number or a part number.

In the examples listed the surface finish may be removed by laser etching.

In a variation of the examples of the invention, the surface of the explosive charge case may include a portion of the surface finish that has been removed by laser etching to expose the bare metal of the metallic housing. Moreover, the surface finish may be removed by laser etching and the underlying metal may be scorched by a laser.

### BRIEF DESCRIPTION OF THE DRAWINGS

For a thorough understating of the present invention, reference is made to the following detailed description of the preferred embodiments, taken in conjunction with the accompanying drawings in which reference numbers designate like or similar elements throughout the several figures of the drawing. Briefly:

FIG. 1 is an isometric view of a typical downhole shaped charge with the labeling etched on the side of the charge case.

FIG. 2 is a side view of a typical downhole shaped charge with the labeling etched on the side of the charge case.

FIG. 3 is an isometric view of a typical downhole jet cutter with the labeling etched on the side of the jet cutter case.

FIG. 4 is a side view of a typical downhole jet cutter with the labeling etched on the side of the jet cutter case.

### DETAILED DESCRIPTION

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems and method steps. It is to be expected that various equivalents, alternatives, and modifications are possible within the scope of the appended claims. For instance, an energetic device in this specification may include, but is not limited to, a shaped charge or a jet cutter.

A typical perforating gun comprises a gun body that acts as a housing for all of the components necessary for containing the shaped charge 10. The shaped charge 10 includes a shaped charge case 11 that holds the energetic material along with other components necessary for a typical shaped charge. The shaped charge case 11 typically is composed of a high strength metal, such as alloy steel.

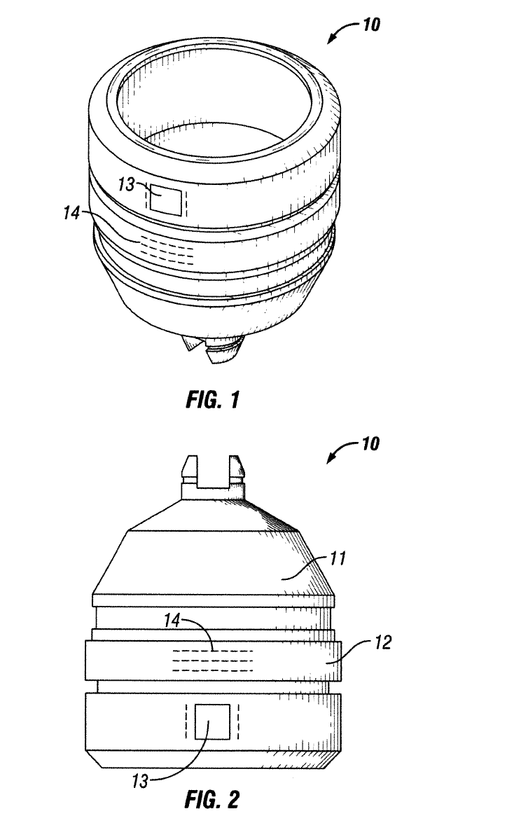

Referring to FIG. 1 and FIG. 2, an embodiment of the invention includes combining an intentionally dark and low reflective surface 12 with a laser marking process to produce readable information 14 and electronically readable information 13. The surface of the shaped charge 12 may be coated or plated. The laser marking is configured to remove the coating or plating from the surface without oxidizing the underlying surface. A laser etching a dark, low reflective surface to expose bright metal will create good contrast while minimizing the amount of exposed reflective material.

The dark background combined with laser markings reduces glare and improves readability by both human and machine.

The dark background of surface 12 can be created through a variety of means that are well known in the art. One example is plating the surface 12 of the shaped charge case 11 with black zinc chromate plating. Another example is to plate the surface 12 of the shaped charge case 11 with olive zinc chromate plating. Examples of composition materials that can be used in the plating material include, but are not limited to, either hexavalent or trivalent zinc chromate. Furthermore, a matte finish may be specified to further reduce reflectivity.

Black and olive zinc chromate plating is more expensive than commonly used clear or yellow colors. The chemicals used to create the black color in the zinc chromate process cause the shaped charge case 11 to become non-conductive. Other colors, including olive, clear or yellow may be conductive. Typically, a conductive surface 12 is preferred to prevent the buildup of electrostatic charges, which may be a safety hazard for the energetic material within the shaped charge. Hexavalent black zinc chromate for instance may not appear to be conductive with an ordinary continuity meter, however it may be conductive enough in this application for treating the surface 12. In this application, where the Hexavalent black zinc chromate is used to plate the surface 12 of the shaped charge case 11, it actually can meet industry requirements for electrostatic discharge.

Not all platings or coatings are applicable to this invention. For instance, a black oxide may be impregnated with oil or wax to enhance its corrosion resistance. However, the oil or wax creates an altered appearance on the underlying surface when the coating is removed. This altered appearance is discolored and produces a relatively poor contrast against the black surface compared to bright metal. The reduced contrast impacts the readability of the information on the shaped charge 10.

There must be sufficient contrast between the coating and the surface exposed in order to create the contrast needed to generate readable information. One example of insufficient contrast is using clear plating with a matte finish. This reduces overall glare, but results in a low contrast between the lower surface exposed by the laser etching and the surface.

An embodiment of the invention includes zinc plating the charge case 11 with black trivalent chromate per ASTM B633-13, finish type V, class SC2, matte finish with the marking laser configured to remove the zinc plating without darkening the underlying surface 12. This embodiment will produce an effective contrast between the information being etched and the overall surface of the shaped charge case, resulting in improved readability for human eyes or electronic scanning devices.

Another embodiment of the invention includes plating the charge case 11 with hexavalent black zinc chromate and marking using a laser configured to remove the zinc plating without darkening the underlying surface 12. This embodiment will produce an effective contrast between the information being etched and the overall surface of the shaped charge case, resulting in improved readability for human eyes or electronic scanning devices.

In a variation of the disclosed embodiments, the brightener component can be removed or diluted from the zinc chromate finish. This will increase the contrast between the etched surface and the surface of the shaped charge by reducing glare.

In at least one example of the invention, an explosive metallic charge case 11 having a relatively dark surface finish, a portion of the metallic housing having exposed bare metal to convey human readable information 14 and electronically readable information 13, wherein the arrangement of the exposed bare metal and relatively dark surface finish convey information.

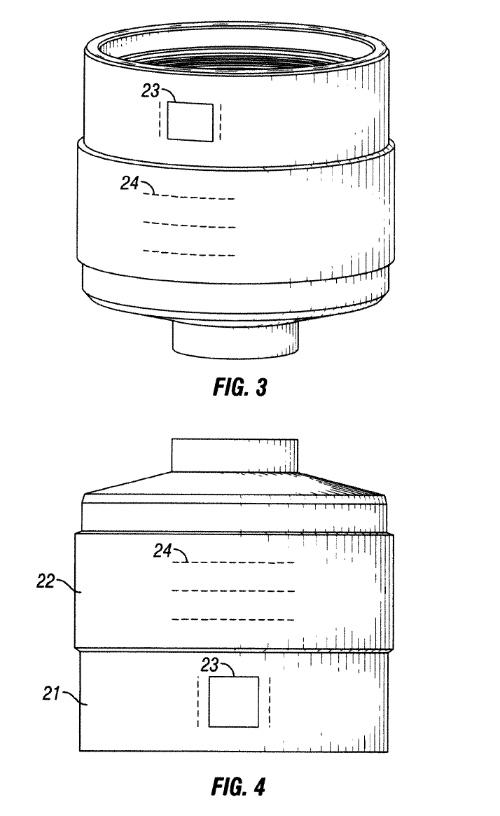

Referring to FIG. 3 and FIG. 4, the invention also can apply to the surface 22 of a jet cutter charge case 21. A jet cutter 20 is used to sever downhole tubulars and generally is comprised of one of more shaped charges that act to give a cutting jet that spreads out radially. There are rules and regulations that require the jet cutter 20 to be marked in order for people and machines to be able to ascertain critical information about the origins and characteristics of the device.

In another embodiment, a jet cutter case 21 is marked in similar fashion to a shaped charge case 11 as disclosed herein. A jet cutter 20 is an explosive shaped charge that has a circumferential V-type shape. The explosive is combined with a liner. The components are all contained in a housing. The jet cutter 20 is lowered to the desired point where the separation of the tubular is desired. When the jet cutter 20 is detonated, it will generate a jet of high energy plasma, typically around 360 degrees, that will severe the tubular. Afterwards, the upper portion of the tubular is pulled out of the well. Then the operator can use a fishing tool to remove the still stuck lower portion of the tubular. The jet cutter case 21 is coated or plated with a finish. In this example the finish is zinc chromate plating. The human readable information 24 and electronically readable information 23 that needs to be placed on the tubing cutter can be achieved by laser etching the plated surface to expose the bare metal of the metallic surface of the jet cutter case 21.

In at least one example of the invention, an explosive metallic jet cutter charge case 21 having a relatively dark surface finish, a portion of the metallic housing having exposed bare metal to convey human readable information 24 and electronically readable information 23, wherein the arrangement of the exposed bare metal and relatively dark surface finish convey information.

The dark background of surface 22 can be created through a variety of means that are well known in the art. One example is plating the surface 22 of the jet cutter charge case 21 in black zinc chromate plating. Another example is to plate the surface 22 of the jet cutter charge case 21 in olive zinc chromate plating. Examples of composition materials that can be used in the plating material include, but are not limited to, either hexavalent or trivalent chromate. Furthermore, a matte finish may be specified to further reduce reflectivity.

In variation of any of the examples listed of the invention, the arrangement of the exposed bare metal and relatively dark surface finish comprise a barcode, a two-dimensional barcode, an identification number, a manufacturer name, a manufacturer location, a place of manufacture, convey an explosive charge weight, an explosive charge type, or an explosive warning. The corrosion resistant finish may be a black zinc chromate finish, a zinc chromate finish without brighteners, an olive zinc chromate finish, or a zinc chromate finish.

Moreover, in any of the examples, the identification number may include at least a serial number or a part number. In the examples listed the surface finish may be removed by laser etching.

In variation of the examples of the invention, the surface of the explosive charge case includes a portion of the surface finish that has been removed by laser etching to expose the bare metal of the metallic housing. Moreover, the surface finish may be removed by laser etching and the underlying metal may be scorched by a laser. In these examples a laser is referenced as a device for etching the plating, but the use of a laser is not intended to be limiting. A person of ordinary skill in the art would recognize that other manufacturing processes and instruments can achieve the same result, including but not limited to chemical etching, machining the surface, stamping, or etching by hand.

An embodiment of the invention includes zinc plating the jet cutter charge case 21 with black trivalent chromate per ASTM B633-13, finish type V, class SC2, matte finish with the markings laser configured to remove the zinc plating without darkening the underlying surface 22. This embodiment will produce an effective contrast between the information being etched and the overall surface of the shaped charge case, resulting in improved readability for human eyes or electronic scanning devices.

Another embodiment of the invention includes plating the jet cutter charge case 21 with hexavalent black zinc chromate and using the marking laser configured to remove the plating without darkening the underlying surface 22. This embodiment will produce an effective contrast between the information being etched and the overall surface of the shaped charge case, resulting in improved readability for human eyes or electronic scanning devices.

Although the invention has been described in terms of particular embodiments which are set forth in detail, it should be understood that this is by illustration only and that the invention is not necessarily limited thereto. Alternative embodiments and operating techniques will become apparent to those of ordinary skill in the art in view of the present disclosure. Accordingly, modifications of the invention are contemplated which may be made without departing from the spirit of the claimed invention. In particular, use of the terms “etching”, “shaped charge”, “jet cutter”, “plating”, “coating”, “human readable information”, and “electronically readable information” herein and within the claims to follow are defined expansively to encompass equivalent terms that are well known in the art.

1. An explosive charge case comprising:
a metallic housing;
a portion of the metallic housing having a relatively dark surface finish;
a portion of the metallic housing having exposed bare metal;
wherein the arrangement of the exposed bare metal and relatively dark surface finish convey information.

2. The explosive charge case of claim 1 wherein the arrangement of the exposed bare metal and relatively dark surface finish comprise a barcode.

3. The explosive charge case of claim 1 wherein the arrangement of the exposed bare metal and relatively dark surface finish comprise a two-dimensional barcode.

4. The explosive charge case of claim 1 wherein the arrangement of the exposed bare metal and relatively dark surface finish comprise an identification number.

5. The explosive charge case of claim 4 wherein the identification number comprises a serial number.

6. The explosive charge case of claim 4 wherein the identification number comprises a part number.

7. The explosive charge case of claim 1 wherein the arrangement of the exposed bare metal and relatively dark surface finish convey a manufacturer name.

8. The explosive charge case of claim 1 wherein the arrangement of the exposed bare metal and relatively dark surface finish convey a manufacturer location.

9. The explosive charge case of claim 1 wherein the arrangement of the exposed bare metal and relatively dark surface finish convey a place of manufacture.

10. The explosive charge case of claim 1 wherein the arrangement of the exposed bare metal and relatively dark surface finish convey an explosive charge weight.

11. The explosive charge case of claim 1 wherein the arrangement of the exposed bare metal and relatively dark surface finish convey an explosive charge type.

12. The explosive charge case of claim 1 wherein the arrangement of the exposed bare metal and relatively dark surface finish convey an explosive warning.

13. The explosive charge case of claim 1 wherein the relatively dark surface finish is a corrosion resistant finish.

14. The explosive charge case of claim 1 wherein the relatively dark surface finish is a black zinc chromate finish.

15. The explosive charge case of claim 1 wherein the relatively dark surface finish is a zinc chromate finish without brighteners.

16. The explosive charge case of claim 1 wherein the relatively dark surface finish is an olive zinc chromate finish.

17. The explosive charge case of claim 1 wherein the relatively dark surface finish is a black oxide finish.

18. The explosive charge case of claim 1 wherein the relatively dark surface finish is a zinc chromate finish.

19. The explosive charge case of claim 1 wherein the surface finish has been removed by laser etching.

20. The explosive charge case of claim 1 wherein a portion of the surface finish has been removed by laser etching to expose the bare metal of the metallic housing.

21. The explosive charge case of claim 1 wherein the surface finish has been removed by laser etching and the underlying metal has been scorched by a laser.

22. The explosive charge case of claim 1 wherein the relatively dark surface finish is a trivalent black chromate finish.

23. The explosive charge case of claim 1 wherein the relatively dark surface finish is a hexavalent black zinc chromate finish.

24. An explosive shaped charge comprising:
a metallic charge case;
a portion of the metallic housing having a relatively dark surface finish;
a portion of the metallic housing having exposed bare metal;
wherein the arrangement of the exposed bare metal and relatively dark surface finish convey information.

25. The explosive charge case of claim 24 wherein the arrangement of the exposed bare metal and relatively dark surface finish comprise a barcode.

26. The explosive charge case of claim 24 wherein the arrangement of the exposed bare metal and relatively dark surface finish comprise a two-dimensional barcode.

27. The explosive charge case of claim 24 wherein the arrangement of the exposed bare metal and relatively dark surface finish comprise a model number.

28. The explosive charge case of claim 24 wherein the arrangement of the exposed bare metal and relatively dark surface finish convey a manufacturer name.

29. The explosive charge case of claim 24 wherein the arrangement of the exposed bare metal and relatively dark surface finish convey a manufacturer location.

30. The explosive charge case of claim 24 wherein the arrangement of the exposed bare metal and relatively dark surface finish convey a place of manufacture.

31. The explosive charge case of claim 24 wherein the arrangement of the exposed bare metal and relatively dark surface finish convey an explosive charge weight.

32. The explosive charge case of claim 24 wherein the arrangement of the exposed bare metal and relatively dark surface finish convey an explosive charge type.

33. The explosive charge case of claim 24 wherein the arrangement of the exposed bare metal and relatively dark surface finish convey an explosive warning.

34. The explosive charge case of claim 24 wherein the relatively dark surface finish is a corrosion resistant finish.

35. The explosive charge case of claim 24 wherein the relatively dark surface finish is a black zinc chromate finish.

36. The explosive charge case of claim 24 wherein the relatively dark surface finish is an olive zinc chromate finish.

37. The explosive charge case of claim 24 wherein the relatively dark surface finish is a black oxide finish.

38. The explosive charge case of claim 24 wherein the relatively dark surface finish is a zinc chromate finish.

39. The explosive charge case of claim 24 wherein the surface finish has been removed by laser etching.

40. The explosive charge case of claim 24 wherein a portion of the surface finish has been removed by laser etching to expose the bare metal of the charge case.

41. The explosive charge case of claim 24 wherein the surface finish has been removed by laser etching and the underlying metal has been scorched by a laser.

42. The explosive charge case of claim 24 wherein the arrangement of the exposed bare metal and relatively dark surface finish comprise an identification number.

43. The explosive charge case of claim 42 wherein the identification number comprises a serial number.

44. The explosive charge case of claim 42 wherein the identification number comprises a part number.

45. The explosive charge case of claim 24 wherein the relatively dark surface finish is a zinc chromate finish without brighteners.

46. The explosive charge case of claim 24 wherein the relatively dark surface finish is a trivalent black chromate finish.

47. The explosive charge case of claim 24 wherein the relatively dark surface finish is a hexavalent black zinc chromate finish.

48. A method for labeling a shaped charge comprising:
finishing an outer surface of a shaped charge case with a relatively dark surface finish;
removing a portion of the surface finish to expose bare metal
wherein the arrangement of the exposed bare metal and relatively dark surface finish conveys information.

49. The explosive charge case of claim 48 wherein the arrangement of the exposed bare metal and relatively dark surface finish comprise a barcode.

50. The explosive charge case of claim 48 wherein the arrangement of the exposed bare metal and relatively dark surface finish comprise a two-dimensional barcode.

51. The explosive charge case of claim 48 wherein the arrangement of the exposed bare metal and relatively dark surface finish comprise a model number.

52. The explosive charge case of claim 48 wherein the arrangement of the exposed bare metal and relatively dark surface finish convey a manufacturer name.

53. The explosive charge case of claim 48 wherein the arrangement of the exposed bare metal and relatively dark surface finish convey a manufacturer location.

54. The explosive charge case of claim 48 wherein the arrangement of the exposed bare metal and relatively dark surface finish convey a place of manufacture.

55. The explosive charge case of claim 48 wherein the arrangement of the exposed bare metal and relatively dark surface finish convey an explosive charge weight.

56. The explosive charge case of claim 48 wherein the arrangement of the exposed bare metal and relatively dark surface finish convey an explosive charge type.

57. The explosive charge case of claim 48 wherein the arrangement of the exposed bare metal and relatively dark surface finish convey an explosive warning.

58. The explosive charge case of claim 48 wherein the relatively dark surface finish is a corrosion resistant finish.

59. The explosive charge case of claim 48 wherein the relatively dark surface finish is a black zinc chromate finish.

60. The explosive charge case of claim 48 wherein the relatively dark surface finish is an olive zinc chromate finish.

61. The explosive charge case of claim 48 wherein the relatively dark surface finish is a black oxide finish.

62. The explosive charge case of claim 48 wherein the relatively dark surface finish is a zinc chromate finish.

63. The explosive charge case of claim 48 wherein the surface finish has been removed by laser etching.

64. The explosive charge case of claim 48 wherein a portion of the surface finish has been removed by laser etching to expose the bare metal of the shaped charge case.

65. The explosive charge case of claim 48 wherein the surface finish has been removed by laser etching and the underlying metal has been scorched by a laser.

66. The explosive charge case of claim 48 wherein the arrangement of the exposed bare metal and relatively dark surface finish comprise an identification number.

67. The explosive charge case of claim 66 wherein the identification number comprises a serial number.

68. The explosive charge case of claim 66 wherein the identification number comprises a part number.

69. The explosive charge case of claim 48 wherein the relatively dark surface finish is a zinc chromate finish without brighteners.

70. The explosive charge case of claim 48 wherein the relatively dark surface finish is a trivalent black chromate finish.

71. The explosive charge case of claim 48 wherein the relatively dark surface finish is a hexavalent black zinc chromate finish.
